(19) United States
(12) Patent Application Publication
(10) Pub. No.: US 2010/0307850 A1
(43) Pub. Date: Dec. 9, 2010

(54) Wheelchair Drive Base Platform

(76) Inventor: Charlie Allen, So. Charleston, WV (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/481,282

(22) Filed: Jun. 9, 2009

(51) Int. Cl. B60P 3/06; B60P 3/07; B60K 25/08

(52) U.S. Cl. 180/198

(57) ABSTRACT

A platform drive base that is mounted by a vehicle, in particular an electric wheelchair that supplies power and control of the drive base allowing the wheelchair to traverse compromising terrain. Wheels of the wheelchair spin freely when mounted on the platform surface. An axle connects to the drive base and the drive train of the wheel chair. As the wheel chair wheels spin, the axle communicates the rotation to the wheels of the drive base. Each wheel of the drive base communicates independently with each wheel of the wheelchair allowing the base to be controlled by the wheelchair controls.

### FIELD OF THE INVENTION

The present invention relates to mobility devices for traversing all-terrain. In particular the present invention is a platform that engages with a mounted power source which provides driving means to the platform. The platform supports a vehicle, such as an electric wheelchair and integrates with the driving system of a wheelchair, for example, to allow a wheelchair to be capable of traversing all-terrain including water.

### BACKGROUND OF THE INVENTION

It has been estimated that at least 25 million persons have mobility problems. Of these, approximately 500,000 use or require the assistance of a wheelchair. Wheelchairs typically available in the marketplace generally transport an operator through common and domestic areas and can be powered and maneuvered either manually or electrically depending on the operator's need or physical limitation.

Wheelchairs are typically used as an aide or solution to a variety of mental or physical restrictions experienced by people that generally concern mobility. A common physical restriction may be paralysis resulting from spinal cord related injuries or consequences associated with muscular dystrophy, multiple sclerosis, polio, cerebral palsy, arthritis or similar which amount to a limited use of a person's legs. Other restrictions may include consequences of obesity or fatigue.

Depending on the injury or condition, people who use wheelchairs may do so on a short or long term duration and are generally capable of performing all necessary and daily activities not limited to shopping, working, driving cars, playing sports, fishing, etc. all while being seated in their wheelchair. People who decide to operate a wheelchair contribute to society as same with one who does not and are typically only limited by their environment. Furthermore, it is not unknown for wheel chair operators to physically, mentally or socially outperform those who do not have temporary or permanent limited use of their legs, including: the 32d President of the United States, Franklin Delano Roosevelt, who currently is the only U.S. president to have served more than two terms; renowned British theoretical physicist, Stephen William Hawking; and former drummer for The Cadillacs, Theodore (Teddy) DeReese Pendergrass, Sr.

In order to perform some tasks, it may necessary for an operator to navigate a wheelchair over compromising terrain or thwart other obstacles which may lead to an operator's loss of time, energy, interest, concern or even involvement and participation in an activity that could include salvaging something from peril.

Typically it is the onerous of an operator to modify their surroundings appropriately in order for many obstacles to be traversable. Sometimes, it is up to business owners or governmental entities to assure all members of society and customers alike share the same fair access to all goods and services. It is not unknown for individuals, businesses or governmental entities to modify publically accessible areas to make such areas easier to maneuver about, such as install ramps or widen hallways. For example, The Americans with Disabilities Act sets forth certain requirements and guidelines for providing fair access and includes imposition and usage of access ramps for wheelchair users.

Even with these modifications and efforts, there still exist circumstances that arise where an operator will have complications related to public access such as to a park, a grassy knoll, the beach, the woods, a body of water, stairs, etc. Generally the operator remains at the mercy of the environment and must rely solely on the capabilities and performance of the wheelchair or simply remain at bay and be prevented from participation completely.

In order to overcome many of these problems, operators are compelled to purchase a more particular wheelchair designed for different environments, rely on transport by others or be denied access. To purchase a wheelchair for different environments may prove to be costly and sometimes may not be proper for general uses like in a hallway, shopping center or other discrete locations.

There is a need for a device capable of transporting a wheelchair and operator across all-terrain.

### SUMMARY OF THE INVENTION

The present invention meets the needs presented above by providing a universal platform (which may also be referred to as a drive base) that supports an electric wheelchair. The platform adapts and/or integrates with the driving system of a wheelchair to allow a wheelchair and operator to traverse all-terrain including water.

The present invention drive base can be used for movably supporting a powered vehicle that has at least one drive wheel, the drive base comprising:

a platform;

a movable support on the platform adapted to rotatably support the drive wheel of the vehicle when the vehicle is held stationary on the platform;

a propulsion device carried by the platform and adapted to exert a motive force to move the platform across a surface on which the platform is supported; and

an axle carried by the platform in a position substantially coaxial with the drive wheel of the vehicle when on the movable support, the axle being operatively connected to the propulsion device and adapted to releasably engage the drive wheel of the vehicle so as to transfer motive power from the drive wheel of the vehicle to the propulsion device.

In an embodiment of the invention, an electric wheelchair mounts a platform. This may be accomplished by use of a ramp that connects to the drive base. The ramp may be retractable or removable. A guide on the ramp, such as a rail or track, may be used to steer the wheelchair onto a desired position on the surface of the drive base.

When on the surface of the drive base, the drive train of the wheelchair, or the wheelchair drive wheels, mounts a set of free rolling or unlocked rollers. When mounted, the wheelchair is stationary, as free spinning of the drive wheels will prevent the wheelchair to move on the surface. The wheelchair may be further secured to surface of the drive base by use of wheel locks and other supports. Once immobilized on the drive base, axles extending from the drive base engage with the drive train of the wheelchair.

As the wheelchair drive wheels spin over the set of free rollers, the axles attached to the drive base are caused to rotate. The axles turn gears which connect to wheels causing the drive base to move.

It is an object of the invention to have a drive base, having a mountable surface integrated with the driving system of a wheelchair, to allow an operator to traverse all-terrain by use of the wheelchair controls. When not in use, the base may be stored, carried, or transported in tow.

The foregoing objects, features and advantages, as well as others will be more fully understood and better appreciated by reference to the following drawings, specification and claims.

### BRIEF DESCRIPTION OF THE DRAWINGS

FIG. 1 is a perspective view of an embodiment of the invention

FIG. 2 is a top plan view of an embodiment of the invention showing engaging components

FIG. 3 is a side view of an embodiment of the invention

FIG. 4 is a partial perspective view of an embodiment of the invention showing drive base platform engaging with mounted wheelchair

FIG. 5 is a partial-perspective view of an embodiment of the invention showing engagement components.

### DETAILED DESCRIPTION OF THE INVENTION

The invention is a drive base that comprises a mountable platform and a propulsion device carried by the platform and adapted to exert a motive force to move the platform across a surface on which the platform is supported that engages with driving means attached to the platform.

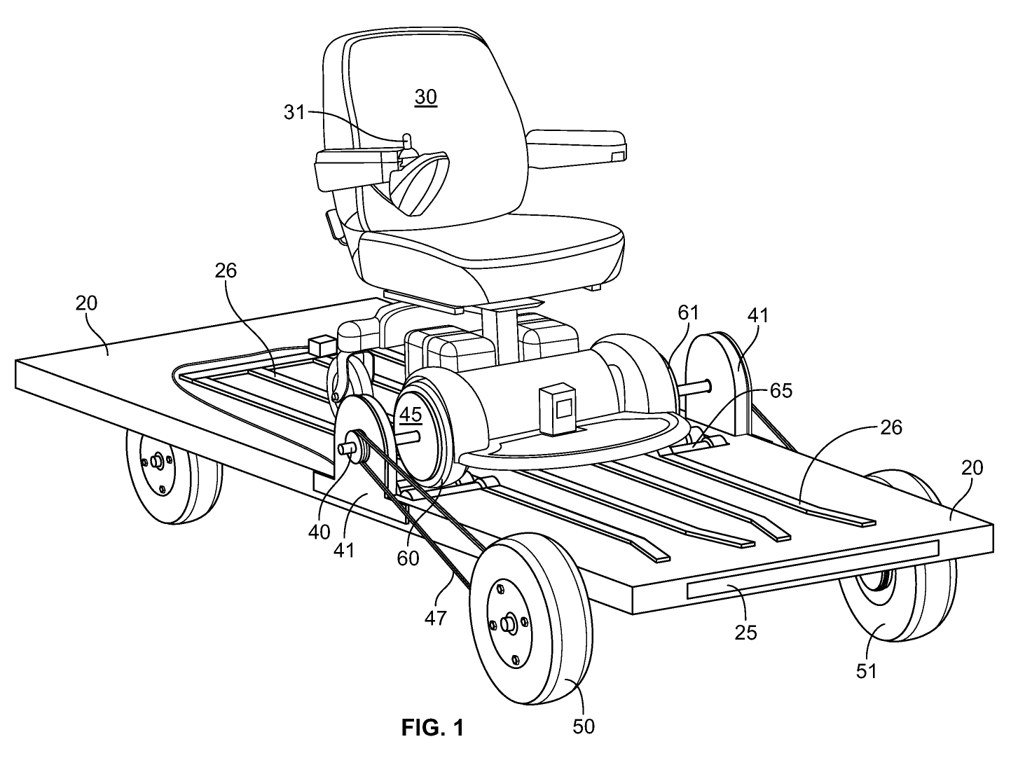

FIG. 1 shows an embodiment of the instant invention wherein the propulsion device or power source is shown exemplified as an electric wheel chair (30). The electric wheel chair (30) has a drive train that consists of a left drive wheel (61) and a right drive wheel (60). The electric wheel chair (30) has a joystick (31) which controls the rate of the rotation of the drive wheels (60, 61). Joystick (31) may also be substituted by a mouthpiece or any other method used to conduct a wheelchair. When driven, the direction of the wheelchair is determined by the rotation of drive wheels (60, 61). For example, if rotation is applied only to the left drive wheel (61), the wheelchair will turn right. Although the power source is shown as an electric wheelchair (30) it is possible to be substituted by other means.

Platform (20) is shown in FIG. 1 fully supporting wheelchair (30). Platform (20) may be constructed out of any material capable of supporting weight such as a wheelchair, operator and additional components or articles that are to be fully supported by the platform drive base. Materials that may be considered include those that are organic, synthetic, man-made and are not limited to fibrous glass, metals, plastics, alloys, stone and wood.

Connected to platform (20) is housing(s) (41) which is shown attached to opposite sides of platform (20); however, they may be attached likewise to the upper surface. Housings (41) rotatably support axle(s) (40) which are adapted to engage drive wheels (60, 61). Similar to platform (20), housings (41) may be constructed of any acceptable material and may be attached to platform (20) by any known means not limited to welding or rivets when metal is used as the composite material or prepared as a molded single unit along with platform (20). A preferred method of attachment could be any that would allow housing(s) (41) to be able to either be substituted or modifiable in order to adjust the positioning of axle(s) (40) so they may engage with other propulsion devices. Furthermore, it is an embodiment of the invention to also allow the axle(s) (40) to be adjusted, when necessary. An example of an adjustment would be to position axle(s) (40) either horizontally, vertically or both, in housing (41) by use of gears, not shown.

Axle(s) (40) are carried by platform (20) in a position substantially coaxial with the drive wheel (60,61) of the vehicle when on movable supports (65), the axle (40) being operatively connected to the propulsion device (50,51) and adapted to releasably engage the drive wheel of the vehicle (60,61) so as to transfer motive power from the drive wheel (60,61) of the vehicle to the propulsion device shown as wheels (50,51) for example.

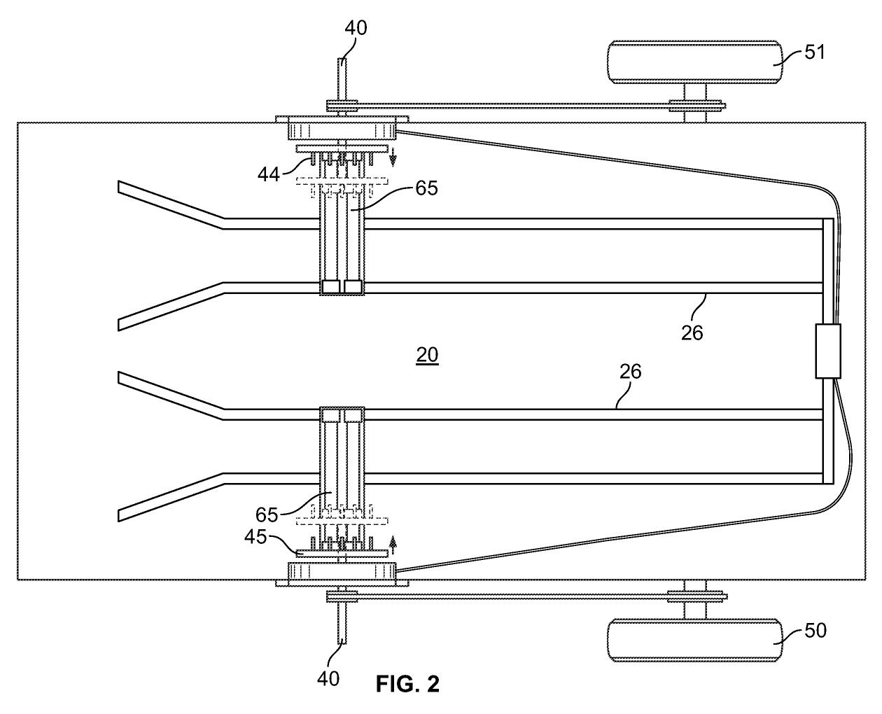

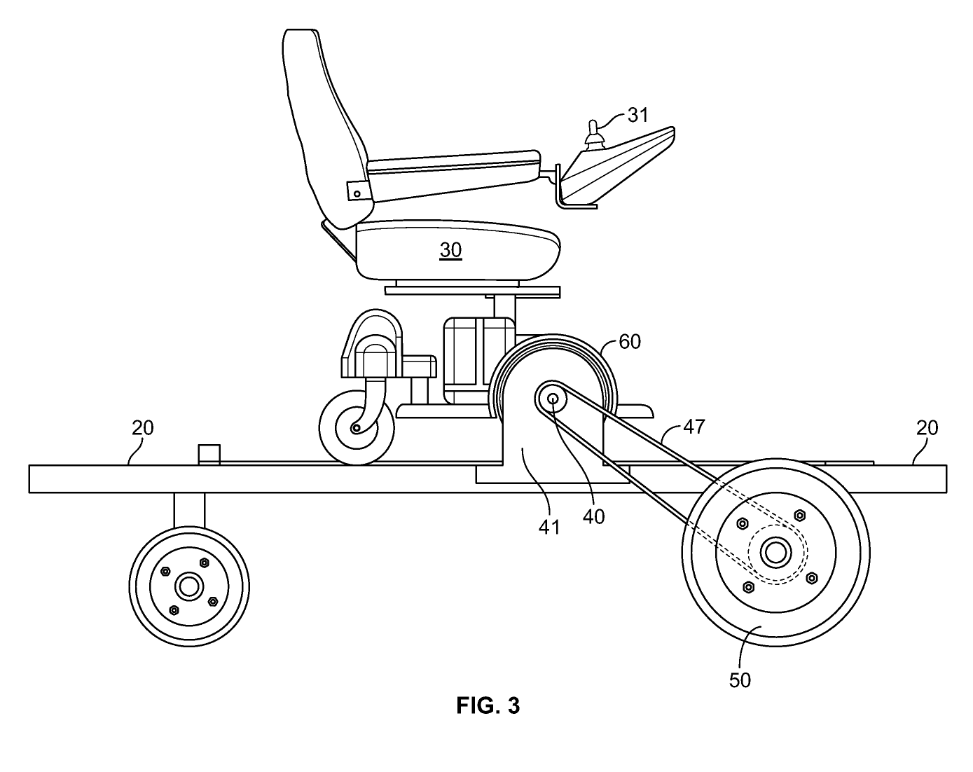

FIG. 2 shows a plan view of an embodiment of the invention without the power source. As shown, platform (20) has guide rails (26) and a movable support (65) on the platform adapted to rotatably support the drive wheel of the vehicle when the vehicle is held stationary on the platform. Acceptable movable supports (65) may include rollers, as shown and referenced herein, wheels, bearings, ribbons or anything that would offset rotation of a vehicle drive system and keep a mounted vehicle stationary. FIG. 2 shows an embodiment where guide rails (26) lead a propulsion device onto platform (20) from the rear end (or opposite end as shown in FIGS. 1, 3 and 4). FIG. 2 further shows guide rails (26) sized about movable support (65) allowing a preferred embodiment of guiding a propulsion device onto platform (20) depending on the propulsion device or situation. In some instances, it may be preferred to have guide rails (65) adjustable based on the location, or drive plane, of the wheels which are desired to be directed onto platform (20).

As shown in FIG. 2, rollers (65) are separated and arranged on platform (20) particularly to accommodate drive wheels (60, 61) of wheelchair (30) when mounted on platform surface (20). FIG. 2 shows that rollers (65) consist of a set of two independent rollers orientated in parallel to each. In this embodiment, the axis of rollers (65) are on the same axial plane as each and may further be on the same axial plane as surface (20), or above, but are preferably just below surface (20), i.e., recessed, allowing for an easier engagement and disengagement for drive wheels (60, 61) when the wheelchair (30) is both mounting and dismounting surface (20). The arrangement may be modified depending on the movable support used or preference of the driver or other limitations by a mounted vehicle/propulsion device.

Returning to the guide rails (26), they may be used to ensure that wheelchair (30) remains on platform (20) and may also be used to assist in positioning wheelchair (30) to a desired surface location, for example onto the set of rollers (65). Furthermore, guide rails (26) may also be used on the surface of a ramp (25) to allow operator of wheelchair (30) to mount platform surface (20) in alignment with the rollers (65). Ramp (25) is shown in FIG. 1 as retracted within platform (20). It is an embodiment of the invention however to have the option of the ramp (25) being able to extend and retract from within the platform, hinged or releasably attached. It is preferable to have ramp (25) extend anteriorly, i.e. from rear of platform (20), according to the embodiment as shown in FIG. 2.

When wheelchair (30) mounts surface (20) and is guided into position onto rollers (65), the rollers (65) may desirously be unlocked (i.e., unrestricted and able to roll free) so that when drive wheels (60, 61) contact or mount the rollers (65) drive wheels (60, 61) will loose friction and become stationary on surface (20).

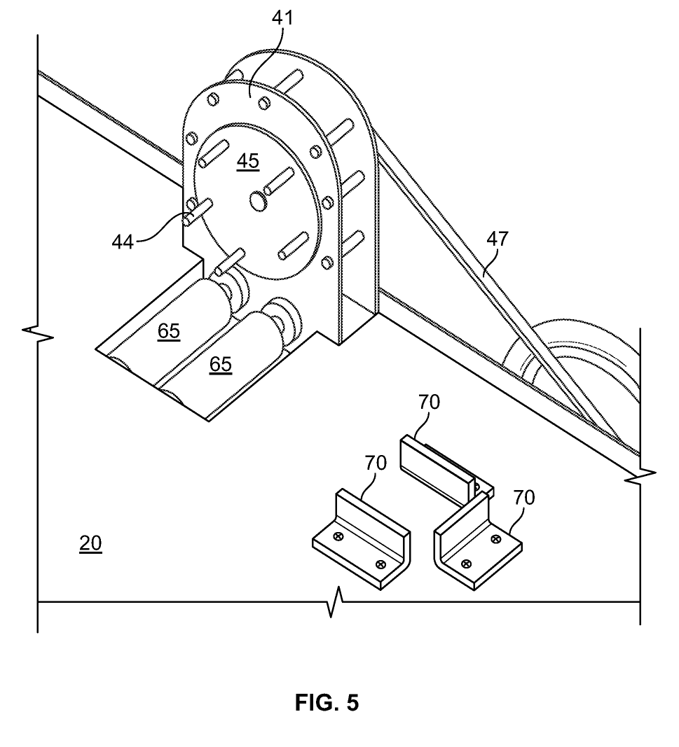

It may be advantageous to further secure and immobilize wheelchair (30) to surface (20) by use of tie downs, locks or the like as a precautionary measure. FIG. 5 shows an example of a metal wheel lock (70) used by the inventor and further has been used to with the addition of a clamp. Lock (70) would be used to keep stationary, wheels that are not powered and could be disposed anywhere on surface (20) depending on the location of the wheelchair non-drive wheels, for example. Indeed, other measures may be taken that can secure a vehicle to platform surface (20) and by no means is this disclosure limiting.

When dismounting platform drive base (20), rollers (65) may be locked providing for traction off platform surface (20). The rollers (65) may be locked in many ways including remotely, manually, use of a switch, etc. An example of locking the rollers (65) manually could include placing a wedge in the space between the rollers (65) or between the rollers and the surface (20). An example of remotely locking the rollers (65) would be to send a radio signal that could cause a mechanism to prevent the axle of the rollers (65) from spinning, similar to moving a switch that would connect the rollers (65) causing them to stop spinning.

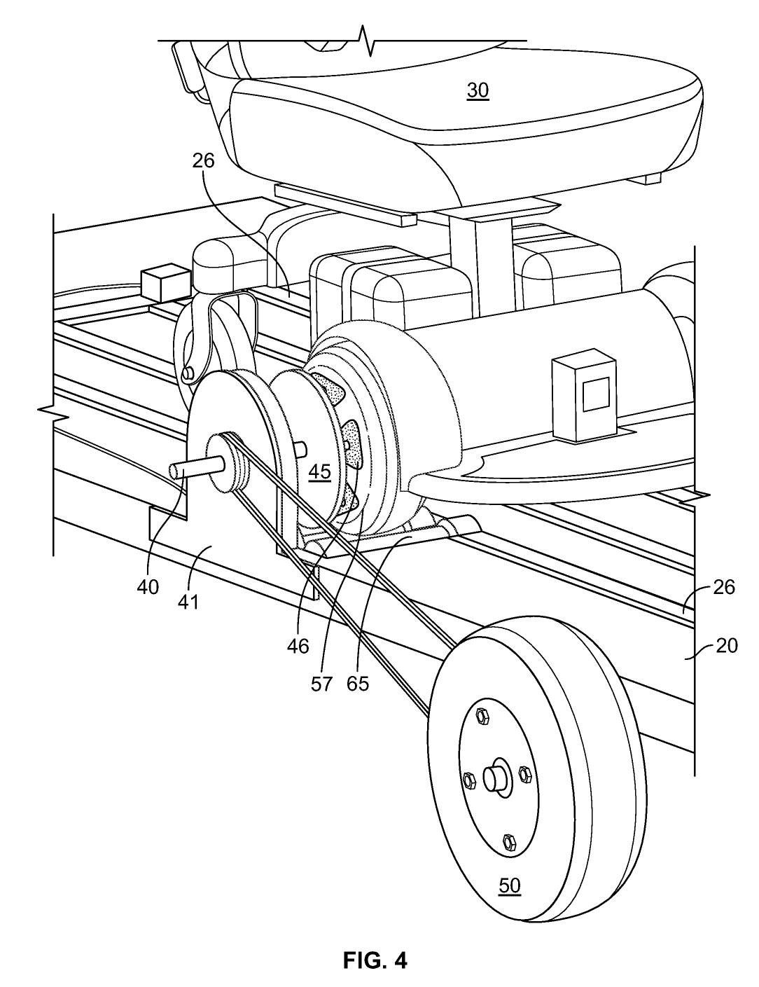

FIG. 4 shows a close up view of drive wheel (60 or 61) mounted on rollers (65 or 66). In this sequence, driving means, shown comprising axle (40) positioned perpendicular to the plane of the drive train, i.e. drive wheel (60 or 61), is now ready to engage with the power source, shown as drive wheel (60 or 61). In an embodiment, axle (40) has two ends, a first end that engages with drive wheel (60 or 61), i.e. the power source, and the second that ultimately drives a second wheel (50 or 51, respectively).

The first end of axle (40) is shown in exemplary form to be engaged with front drive wheel (60 or 61) by use of connecting pins (44) that connect by being inserted into the voids (46) and or spokes of the drive wheels (60, 61). As shown in FIGS. 2, 4 and 5, pins (44) are connected to axle (40) by plate (45). Pins (44) are disposed on plate (45) in order to match with the voids (46) of rims (47); however, axle (40) may connect to other shape plates and have different pin orientations depending on the power source and may otherwise bypass a plate and pin arrangement and directly connect to the power source (for example, connect directly to the axle of the front drive wheels (60, 61). Likewise, plate (45) may connect directly to the edge of rim (47) by tongue and groove or other known means.

The other end of axle (40) is supported by housing (41) in bearings, not shown, which may also be used to provide means that engage and disengage axle (40) with drive wheel (60 or 61). For example a motor may be in housing (41) that move axle (40) in or out in a fashion controlled by a screw and teeth system. FIG. 2 shows the relative movement of axle (40) engaged in broken lines and disengaged in solid lines. This second end of axle (40) and or axle operatively connects to propulsion device, shown as platform wheels (50, 51) by use of means such as a drive belt or chain (47). Depending on the need of the operator wheels (50, 51) can be replaced by varying size wheels or even substituted by other means of transport such as a propeller or paddle, when the base (20) is brought to water, etc.

In practice, the rotation of drive wheels (60, 61) cause axle (40) to rotate. The rotation of axle (40) effectively causes wheel(s) (50, 51) to rotate. When driven, the direction of the platform (i.e., drive base) (20) is determined by the rotation of the front drive wheels (60, 61) which communicate directly with wheels (50, 51). For example, if rotation is applied only to the left front drive wheel (61), the drive base (20) will turn right.

What is claimed is:

1. A drive base for movably supporting a powered vehicle having at least one drive wheel, the drive base comprising:
a platform;
a movable support on the platform adapted to rotatably support the drive wheel of the vehicle when the vehicle is held stationary on the platform;
a propulsion device carried by the platform and adapted to exert a motive force to move the platform across a surface on which the platform is supported; and
an axle carried by the platform in a position substantially coaxial with the drive wheel of the vehicle when on the movable support, the axle being operatively connected to the propulsion device and adapted to releasably engage the drive wheel of the vehicle so as to transfer motive power from the drive wheel of the vehicle to the propulsion device.

2. A drive base comprising
a mountable surface capable of being traversed over a surface by a drive train,
a set of rollers disposed on the upper surface of the mountable surface,
an axle connected to said mountable surface that communicates with said drive train of said mountable surface.

3. The drive base of claim 2 further comprising a power source.

4. The drive base of claim 3 wherein the axle attached to said mountable surface releasably attaches to the power source.

5. The drive base of claim 2 wherein the power source is the drive train of a vehicle.

6. The drive base of claim 5 wherein the drive train of a vehicle comprises the rotation of a wheel.

7. The drive base of claim 6 wherein said wheel mounts the set of rollers.

8. The drive base of claim 2 wherein the axial plane of said axle is located above the axial plane of said mountable surface.

9. The drive base of claim 2 wherein the drive train of the mountable surface comprises a wheel.

10. The drive base of claim 2 wherein the drive train of the mountable surface comprises a propeller.

11. A wheelchair drive base comprising:
a wheelchair,
a base having a drive wheel and a mountable surface, and
an axle attached to the mountable surface that releasably connects to the wheel chair.

12. The wheelchair drive base of claim 11 wherein a set of rollers are disposed on the mountable surface.

13. The wheelchair drive base of claim 12 wherein said axle attaches to a wheel chair wheel.

14. The wheelchair drive base of claim 11 wherein all wheels of the wheelchair are on top of the mountable surface.
